(19) United States
(12) Patent Application Publication
(10) Pub. No.: US 2025/0309323 A1
(43) Pub. Date: Oct. 2, 2025

(54) METHOD FOR FORMING ELECTROCHEMICAL CELLS OF ELECTRICAL BATTERIES

(71) Applicant: G.D S.p.A., Bologna (IT)

(72) Inventor: Gilberto Spirito, Bologna (IT)

(21) Appl. No.: 18/864,189

(22) PCT Filed: May 9, 2023
(86) PCT No.: PCT/IB2023/054775

§ 371 Date: Nov. 8, 2024

(30) Foreign Application Priority Data
May 10, 2022 (IT) 102022000009539

(51) Int. Cl. H01M 10/04; H01M 10/0587

(52) U.S. Cl. CPC H01M 10/0409; H01M 10/0587

(57) ABSTRACT

A method for forming electrochemical cells of electrical batteries. The method comprises preparing a coil comprising a winding of a first separator sheet, a coil comprising a winding of a first electrode sheet, a coil comprising a winding of a second separator sheet and a coil comprising a winding of a second electrode sheet. The sheets are fed towards a movable conveyor by unwinding them from respective coils. A plurality of multi-layer strips is formed, each one comprising a first layer of said first separator sheet, a second layer of said first electrode sheet overlapped to said first layer, a third layer of said second separator sheet overlapped to said second layer and a fourth layer of said second electrode sheet overlapped to said third layer. Each multi-layer strip is fed to a respective winding device by said conveyor and each multi-layer strip is wound onto the respective winding device.

### CROSS-REFERENCE TO RELATED APPLICATION DATA

This application is a U.S. National Stage Application of International Application No. PCT/IB2023/054775, filed May 9, 2023, which claims the benefit of and priority to Italian Patent Application No. 102022000009539, filed May 10, 2022, the disclosure of each is incorporated herein by reference in its entirety.

### FIELD

The present invention relates to a method for forming electrochemical cells of electrical batteries.

### BACKGROUND

Some types of electrical batteries, e.g. those commonly used in electrically powered vehicles, comprise a hollow container inside which there is an electrochemical cell formed of an anode and a cathode separated by an electrolyte membrane.

In lithium-ion cylindrical electrical batteries, a cylindrical electrochemical cell called “jelly roll” or “Swiss roll” is commonly adopted. It consists of four layers of material in the form of a thin foil or sheet. The four layers comprise a cathode layer (hereafter also briefly referred to as “cathode”), usually consisting of elements such as lithium and an oxide of metals such as nickel, manganese, cobalt, an anode layer (hereafter also briefly referred to as “anode”), e.g. graphite, and two separator layers (hereafter also briefly referred to as “separators”), e.g. consisting of an electrically insulating and porous polymer membrane, which are arranged alternating with the cathode layer and the anode layer to separate them. The multi-layer product thus composed is rolled onto itself to form the jelly roll. In conventional cylindrical electrochemical cells, two conductive terminals, called “tabs”, are welded on opposite sides one to the cathode and the other to the anode to make the positive and negative poles of the electric battery. Recently, a type of cylindrical electrochemical cell called “tabless” has been devised, which doe not require welding of terminals since the side edges of the anode and cathode are bended to act as terminals themselves.

The sizes of cylindrical electrochemical cells are standard. The most common sizes are 1865 (diameter equal to 18 mm and axial length equal to 65 mm) and 2170 (diameter equal to 21 mm and axial length equal to 70 mm) for conventional tab cells and 4680 (diameter equal to 46 mm and axial length equal to 80 mm) for “tabless” cells.

In order to produce cells of this type, the anode, cathode and separator are produced on a large scale in the form of continuous sheets wound in respective coils known as “mother coils”, having an axial dimension of more than one metre.

The mother coils are then unwound to cut the individual sheets longitudinally into strips having a transverse width equal to the axial length of the electrochemical cells to be produced. The strips are then individually rewound into smaller coils, known as “daughter coils”.

The daughter coils are treated to remove impurities, e.g. by vacuum drying, and are brought to a dry environment under controlled environmental conditions for the final assembly of the electrochemical cell.

Each daughter coil is unwound and the strips which are unwound from the anode, cathode and separator daughter coils are simultaneously fed, typically by hand, to a winding device along different directions, depositing first the cathode (or anode), then a separator, then the anode (or cathode) and finally the other separator on the winding device, thus creating the jelly roll.

Next, the terminals are welded to the cathode and anode and the jelly roll is placed in a hollow cylindrical container that is filled with an electrolyte solution having a liquid form and then closed and subjected to subsequent forming, degassing, ageing and testing operations.

The Applicant noted that the production process outlined above is costly in terms of production efficiency, especially when provided on a large scale.

Indeed, the Applicant noted that producing mother coils, unwinding mother coils to cut them into strips, rewinding the strips into daughter coils and unwinding the daughter coils to assemble an electrochemical cell on a respective winding device requires retention time in the production plant for each of the above-mentioned coils. Considerable temporary storage space must therefore be provided.

Furthermore, in the Applicant's opinion, the simultaneous winding of the four strips onto the winding device is a delicate operation which, in addition to require a high degree of precision, requires a high level of attention on the side of the operator who feeds said strips to the winding device by hand, in order to prevent the risk of injuries. This creates a bottleneck in the production process that limits the number of electrochemical cells that can be produced in a given time frame. The Applicant has observed that the production process summarised above can be improved.

In fact, the Applicant perceived that if said strips are fed onto a conveyor before being individually wound onto the winding device to create a multi-layer strip which is then automatically fed to the winding device, the need to feed the individual strips to the winding device would be avoided, thus eliminating the aforementioned bottleneck and reducing the risk of injuries to the operator.

According to the Applicant, each multi-layer strip can be formed on the conveyor by cutting the electrode and separator sheets unwound from the mother coils into parallel strips before or immediately after placing them on the conveyor. There is therefore no need for daughter coils, saving production time and storage space.

### SUMMARY

The present invention therefore relates, in a first aspect thereof, to a method for forming electrochemical cells of electrical batteries.

Preferably, a coil comprising a winding of a first separator sheet is prepared.

Preferably, a coil comprising a winding of a first electrode sheet is prepared.

Preferably, a coil comprising a winding of a second separator sheet is prepared.

Preferably, a coil comprising a winding of a second electrode sheet is prepared;

Preferably, said sheets are fed to a conveyor by unwinding them from their respective coils.

Preferably, a plurality of multi-layer strips are formed on the conveyor.

Preferably, each multi-layer strip comprises a first layer of said first separator sheet, a second layer of said first electrode sheet, a third layer of said second separator sheet and a fourth layer of said second electrode sheet.

Preferably, the second layer is overlapped to said first layer.

Preferably, the third layer is overlapped to said second layer.

Preferably, the fourth layer is overlapped to said third layer.

Preferably, said conveyor can be moved along a feeding direction.

Preferably, each multi-layer strip is fed to a respective winding device by said conveyor.

Preferably, each multi-layer strip is wound onto the respective winding device.

In a second aspect thereof, the present invention relates to an apparatus for forming electrochemical cells of electrical batteries.

Preferably, a service area is provided.

Preferably, the service area is configured to support a coil comprising a winding of a first separator sheet.

Preferably, the service area is configured to support a coil comprising a winding of a first electrode sheet.

Preferably, the service area is configured to support a coil comprising a winding of a second separator sheet.

Preferably, the service area is configured to support a coil comprising a winding of a second electrode sheet.

Preferably, a conveyor is provided.

Preferably, the conveyor is configured to support a plurality of multi-layer strips.

Preferably, each multi-layer strip comprises a first layer of said first separating sheet.

Preferably, each multi-layer strip comprises a second layer of said first electrode sheet.

Preferably, each multi-layer strip comprises a third layer of said second separator sheet.

Preferably, each multi-layer strip comprises a fourth layer of said second electrode sheet.

Preferably, said second layer is overlapped to said first layer.

Preferably, said third layer is overlapped to said second layer.

Preferably, said fourth layer is overlapped to said third layer.

Preferably, said conveyor can be moved along a feeding direction.

Preferably, a plurality of winding devices are arranged downstream of said conveyor with reference to said feeding direction.

Preferably, each of said winding devices is configured to receive a respective multi-layer strip.

The multi-layer strips are thus created directly from the electrode and separator sheets which are unwound from the mother coils. In this way, multi-layer strips can be fed to the winding devices without having to create daughter coils.

The multi-layer strips are formed on the conveyor, which is moved along the feeding direction to move them towards the respective winding devices. In this way, all the multi-layer strips move simultaneously in the same direction towards the winding devices.

In this way, the production of the electrochemical cell requires less operator intervention and can be more easily automated.

In the present description, terms such as “horizontal”, “horizontally”, “below”, “above” are used with reference to a spatial arrangement in the configuration of use of the apparatus of the invention.

The term “atmospheric environmental conditions” is used to refer to conditions where the ambient air is not treated with moisture abatement systems.

The term “dry environmental conditions” is used to refer to controlled atmosphere conditions with reduced humidity as prescribed by ISO 7, or further reduced.

The term “sheet” is used to refer to a body having a thickness less than 0.5 mm, preferably less than 0.2 mm.

The electrode and separator sheets referred to herein have a prevailing dimension that defines a longitudinal direction. When the electrode and separator sheets are placed on a conveyor, this longitudinal direction is parallel to the feeding direction of the conveyor.

The term “transverse” or “transversely” is used to refer to a direction inclined to the longitudinal direction, preferably orthogonal to the longitudinal direction, and orthogonal to the dimension along which the thickness of the sheet is measured.

The coils and electrochemical cells referred to in this description are essentially cylindrical in shape.

The term “axial” or “axially” is used to refer to a direction parallel to the winding axis of the coil or electrochemical cell.

The term “radial” or “radially” is used to refer to a direction orthogonal to the axis of the coil or electrochemical cell.

The present invention may have, in one or more of its aspects, at least one of the preferred features described below. These features may be provided individually or in combination with each other, unless expressly stated otherwise.

Preferably, the conveyor is arranged below the service area.

Preferably, the first electrode sheet comprises an anode (or cathode) material.

Preferably, the second electrode sheet comprises a cathode (or anode) material.

Preferably, a plurality of parallel strips of each of said sheets is formed by cutting each of said sheets longitudinally.

Preferably, the plurality of parallel strips of each of said sheets is formed when the sheet is fed towards the conveyor.

Preferably, the plurality of parallel strips of each of said sheets is formed before forming said plurality of multi-layer strips on the conveyor.

Preferably first cutting members are provided.

Preferably, said first cutting members are arranged between said service area and the conveyor.

Preferably, said first cutting members are configured to cut each of said sheets longitudinally into parallel strips.

Preferably, at first the parallel strips of the first separator sheet are deposited on the conveyor, then the parallel strips of the first electrode sheet are deposited, then the parallel strips of the second separator sheet are deposited and then the parallel strips of the second electrode sheet are deposited.

In this way the order of the layers that will form the electrochemical cell is determined.

Preferably, a plurality of longitudinal pieces of multi-layer strips are formed.

Preferably, the plurality of longitudinal pieces of multi-layer strips is formed before winding each multi-layer strip onto the respective winding device.

Preferably, winding each multi-layer strip onto the respective winding device comprises winding each of said longitudinal pieces onto the respective winding device.

Preferably, forming said plurality of longitudinal pieces of multi-layer strips comprises periodically and transversely cutting each of said sheets.

Preferably, said longitudinal pieces of multi-layer strips are all of the same length.

In a preferred embodiment, each of said sheets is cut periodically and transversely before depositing said parallel strips on the conveyor.

In an alternative embodiment, the electrode sheets are cut periodically and transversely before depositing said parallel strips on the conveyor, and the strips of separator sheets are cut periodically and transversely after having been deposited on the conveyor and before being wound onto the winding devices.

In a preferred embodiment, each of said sheets is cut periodically and transversely after forming said parallel strips.

In an alternative embodiment, each of said sheets is cut periodically and transversely before forming said parallel strips.

Preferably, second cutting members are provided.

In a preferred embodiment, the second cutting members are arranged between said service area and the conveyor.

Preferably, the second cutting members are configured to cut each of said sheets periodically and transversely.

Preferably, said second cutting members are arranged at or near said first cutting members.

In an alternative embodiment, the second cutting members for cutting the electrode sheets are arranged between said service area and the conveyor, and the second cutting members for cutting the separator sheets are arranged between the conveyor and the winding devices.

In an embodiment, the feeding of the electrode sheet strips to the conveyor can be temporarily stopped or slowed down before and/or after the electrode sheets are cut periodically and transversely so as to create a gap on the conveyor between two successive longitudinal pieces of electrode sheet.

In this way, for each piece of multi-layer strip which is formed, the longitudinal pieces of the separator sheets protrude longitudinally from the longitudinal pieces of the electrode sheets. The electrochemical cells so formed will thus have a peripheral portion formed exclusively by separator sheets. This helps to isolate the electrode sheets.

Preferably, the parallel strips of the first electrode sheet are deposited on the conveyor in a transversely offset position with respect to the parallel strips of the first separator sheet to create, in each multi-layer strip, a protruding side edge of the first electrode sheet.

Preferably, the parallel strips of the second separator sheet are deposited on the conveyor in a transversely offset position with respect to the parallel strips of the first electrode sheet.

Preferably, the parallel strips of the second electrode sheet are deposited on the conveyor in a transversely offset position with respect to the parallel strips of the first separator sheet and the second separator sheet.

Preferably, the parallel strips of the second electrode sheet are deposited on the conveyor on the opposite side to the protruding side edge of the first electrode sheet to create a protruding side edge of the second electrode sheet in each multi-layer strip.

The protruding side edges form, subsequent to the winding of the electrochemical cell, the electrical terminals of the electrochemical cell electrodes in a “tabless” configuration.

Preferably, before winding each multi-layer strip onto its respective winding device, the protruding side edge of the first electrode sheet is bent longitudinally.

Preferably, before winding each multi-layer strip onto its respective winding device, the protruding side edge of the second electrode sheet is bent longitudinally.

Preferably, a plurality of bending members is provided.

Preferably, the bending members are arranged parallel to each other above said conveyor along a direction parallel to said feeding direction.

Preferably, the bending members are configured to intercept respective side edges of said multi-layer strips.

In this way, the bending of the aforementioned side edges takes place continuously during the movement of the conveyor along the feeding direction.

Preferably, said plurality of bending members comprises first bending members, each configured to intercept the protruding side edge of a respective first electrode sheet.

Preferably, said plurality of bending members comprises second bending members, each configured to intercept the protruding side edge of a respective second electrode sheet.

Preferably, each bending member has a helical profile.

Preferably, said helical profile extends along an axis parallel to the feeding direction.

The helical profiles gradually bend the aforementioned protruding side edges during the movement of the conveyor along the feeding direction.

Preferably, longitudinally bending the protruding side edge of the first electrode sheet comprises intercepting the protruding side edge of the first electrode sheet by a first bending member while the conveyor is moved along said feeding direction.

Preferably, longitudinally bending the protruding side edge of the second electrode sheet comprises intercepting the protruding side edge of the second electrode sheet by a second bending member while the conveyor is moved along said feeding direction.

Preferably, after winding each multi-layer strip onto the respective winding device, the protruding side edge of the first electrode sheet is flattened by overturning it towards a winding axis of the respective winding device.

Preferably, after winding each multi-layer strip onto the respective winding device, the protruding side edge of the second electrode sheet is flattened by overturning it towards a winding axis of the respective winding device.

The flattening of the protruding side edges allows the electrochemical cell terminals to be created in the “tabless” configuration.

Preferably, flattening the protruding side edge of the first electrode sheet comprises forming radial creases in the protruding side edge of the first electrode sheet with respect to the winding axis of the respective winding device.

Preferably, flattening the protruding side edge of the second electrode sheet comprises forming radial creases in the protruding side edge of the second electrode sheet with respect to the winding axis of the respective winding device.

Preferably, a plurality of presser members is provided.

Preferably, each of these presser members is arranged at a respective winding device.

Preferably, each of said presser members is configured to flatten the protruding side edges of the first sheet and the second sheet.

Preferably, prior to winding each multi-layer strip onto the respective winding device, a plurality of cuts is made on said protruding side edges.

The cuts make the protruding side edges discrete along the longitudinal direction and simplify the flattening operations.

Preferably, the plurality of cuts is made on said protruding side edges before forming the plurality of parallel strips of each of said sheets.

Preferably, the plurality of cuts is made on said protruding side edges by longitudinally cutting each of said sheets.

Preferably, the plurality of cuts is made on said protruding side edges when forming said plurality of parallel strips.

Preferably, said cuts extend on said protruding side edges from a free end of said protruding side edges up to a curved inner end.

Preferably, said cuts are J-shaped or sinusoidal. This reduces the risk of the cuts to cause tearing of the strip.

Preferably, third cutting members are provided.

Preferably, the third cutting members are configured to make said plurality of cuts on said protruding side edges.

Preferably, said third cutting members are arranged between said service area and the conveyor.

In an embodiment, said third cutting members are arranged at, or integrated with, said first cutting members.

In an alternative embodiment, the third cutting members comprise a laser cutting device.

Preferably, after winding each longitudinal piece into the respective winding device, said winding device is replaced with a further free winding device for winding thereon a subsequent longitudinal piece of the same multi-layer strip. This reduces dead time between the winding of one piece of multi-layer strip and the next.

In a preferred embodiment, said coils are prepared in dry environmental conditions.

Preferably, said coils are prepared under dry environmental conditions and maintained under such dry environmental conditions while said sheets are unwound from said coils.

In a different embodiment, preparing said coils comprises arranging said coils in a dryer to allow solvents and other contaminants to evaporate from said coils.

In a further different embodiment, said coils are prepared in atmospheric environmental conditions and maintained in such atmospheric environmental conditions while said sheets are unwound from said coils.

Preferably, impurities are evaporated from said sheets continuously after unwinding said sheets from said coils and before forming said plurality of multi-layer strips on the conveyor.

Microwaves can be emitted towards the separator sheets as they are unwound from the respective coils in order to allow evaporation of the impurities from them.

In an embodiment, the conveyor is arranged in a chamber under dry environmental conditions. This reduces the risk of contamination during the formation of the multi-layer strips and while feeding them to the winding devices.

Preferably, during the feeding of said sheets towards the conveyor, the sheets transit from atmospheric environmental conditions to dry environmental conditions.

In a different embodiment, the conveyor is provided in a place with atmospheric environmental conditions.

Preferably, after winding each multi-layer strip onto its respective winding device, the wound multi-layer strip is subjected to a drying treatment.

Preferably, the wound multi-layer strip is dried by vacuum drying.

In an embodiment, said winding devices are arranged in an offset position along said feeding direction.

The offset position allows the mechanical components necessary for the operation of the winding devices to be accommodated while keeping the multi-layer strips adjacent to each other.

In a different embodiment, said winding devices are arranged in an offset position along a direction inclined with respect to said feeding direction. This allows all the longitudinal pieces to travel the same distance to reach the respective winding devices.

Further characteristics and advantages of the present description will become clearer from the following detailed description of preferred embodiments thereof, made with reference to the appended drawings and provided by way of indicative and non-limiting example, in which:

### BRIEF DESCRIPTION OF THE DRAWINGS

FIG. 1 is a schematic side view of an apparatus for forming electrochemical cells of electrical batteries made in accordance with the present invention;

FIG. 2 is a schematic top view, and with some elements removed, of the apparatus of FIG. 1;

FIG. 2A is a detailed view of a detail of the apparatus of FIG. 1;

FIG. 3 is a schematic side view of a different embodiment of an apparatus for forming electrochemical cells for electrical batteries made in accordance with the present invention;

FIG. 4 is a schematic top view, and with some elements removed, of the apparatus of FIG. 3;

FIG. 5 is a schematic top view of a portion of a multi-layer strip formed by the apparatus of the previous figures;

FIG. 6 is a schematic cross-sectional view of the multi-layer strip of FIG. 5;

FIGS. 7 to 10 show respective schematic cross-sectional views of a plurality of multi-layer strips made with the apparatus of FIGS. 1-4 in different configurations;

FIG. 11 is a schematic top view of a detail of the multi-layer strip of FIG. 5;

FIG. 12 is a radial cross-sectional view of an electrochemical cell which can be obtained by the apparatus of FIGS. 1-4;

FIGS. 13 to 16 show respective schematic cross-sectional views of electrochemical cells which can be obtained by the apparatus of FIGS. 1-4.

The representations in the above figures need not necessarily be considered to scale and do not necessarily respect the proportions between the various parts. In the figures, identical or similar elements of different embodiments will be indicated by the same reference numbers.

### DETAILED DESCRIPTION

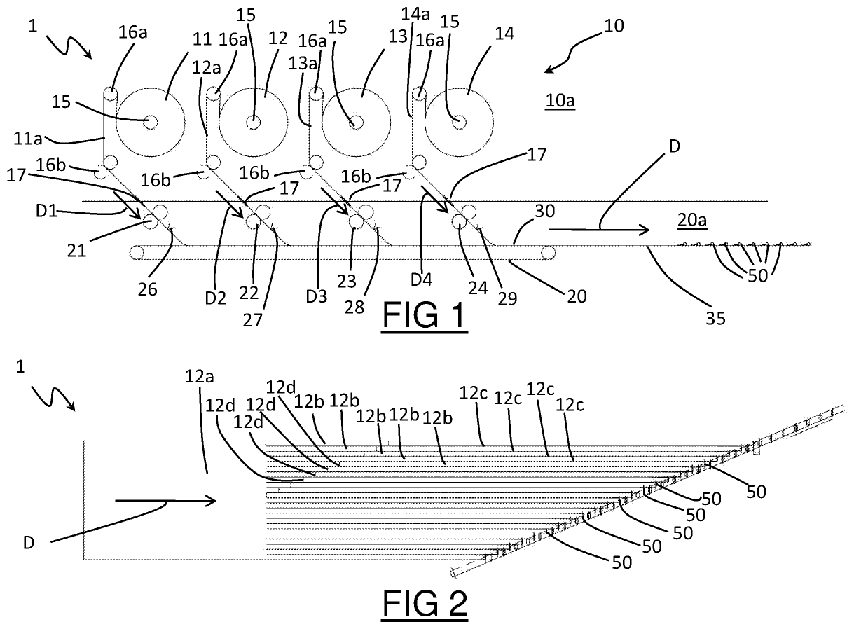

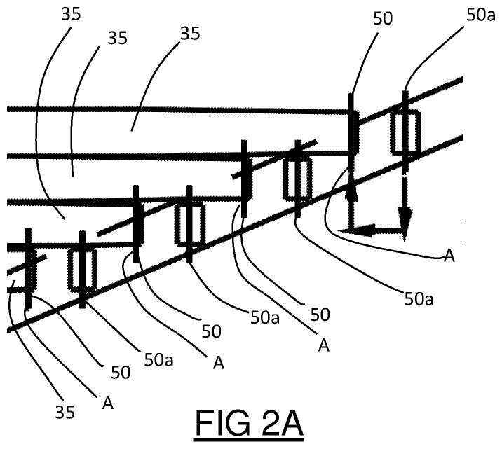

An apparatus for forming electrochemical cells of electrical batteries in accordance with the present invention is illustrated schematically in FIGS. 1 and 2, where it is indicated by the numerical reference 1.

The apparatus 1 comprises a service area 10 configured to support four coils 11, 12, 13, 14 of sheets wound as a continuous tape. The service area 10 comprises four supports 15, e.g. pins, on which the coils 11, 12, 13, 14 can be engaged and disengaged. The four supports 15 can be motorised to carry out a rotation of the coils 11, 12, 13, 14 or they can leave the coils 11, 12, 13, 14 free to rotate by dragging.

In the embodiment shown in FIG. 1, the four supports 15 are arranged equally spaced apart from each other on a vertical plane.

Each of the coils 11, 12, 13, 14 has an axial dimension measured along their respective winding axes of more than 1 m, preferably about 2 m.

Each of the coils 11, 12, 13, 14 has a diameter comprised between 0.4 m and 2 m, preferably comprised between 0.6 m and 1.5 m, even more preferably comprised between 0.8 m and 1.2 m.

Each of the coils 11, 12, 13, 14 has a wound sheet length comprised between 1000 m and 100000 m, preferably between 3000 m and 60000 m, even more preferably between 6000 m and 40000 m.

A first coil 11 of the four coils 11, 12, 13, 14 comprises a winding of a first separator sheet 11a in the form of a continuous tape. The first separator sheet 11a consists of polymer material, e.g. polyethylene, polypropylene or a combination of these two, is microporous, electrically insulating and is configured to be impregnated with an electrolytic liquid. The thickness of the separator sheet 11a is comprised between 5 μm and 30 μm, preferably between 10 μm and 25 μm and even more preferably between 15 μm and 20 μm.

A second coil 12 of the four coils 11, 12, 13, 14 comprises a winding of a first electrode sheet 12a in the form of a continuous tape. The first electrode sheet 12a comprises a conductive metal foil, e.g. aluminium or copper-based, having a thickness between 2 μm and 20 μm, preferably between 4 μm and 15 μm, and even more preferably between 6 μm and 10 μm. The metal foil of the first electrode sheet 12a is coated on one or both sides with a substrate of cathode material, e.g. comprising lithium and one of: cobalt oxide (LiCoO2), manganese oxide (LiMn2O4), nickel manganese cobalt oxide (NMC), iron phosphate (LiFePO4), lithium titanate (Li2TiO3). The total thickness of the first electrode sheet 12a is comprised between 50 μm and 200 μm, preferably between 100 μm and 150 μm, e.g. approximately 125 μm.

The first electrode sheet 12a is intended to form, for example, the cathode of the electrochemical cell.

A third coil 13 of the four coils 11, 12, 13, 14 comprises a winding of a second separator sheet 13a in the form of a continuous tape, similar to the first separator sheet 11a.

A fourth coil 14 of the four coils 11, 12, 13, 14 comprises a winding of a second electrode sheet 14a in the form of a continuous tape. The second electrode sheet 14a comprises a conductive metal sheet, e.g. aluminium or copper-based, having a thickness between 2 μm and 20 μm, preferably between 4 μm and 15 μm, even more preferably between 6 μm and 10 μm. The metal foil of the second electrode sheet 14a is coated on one or both sides with an anode material substrate, e.g. a graphitic material. The second electrode sheet 14a is intended to form, for example, the anode of the electrochemical cell.

The first separator sheet 11a, the first electrode sheet 12a, the second separator sheet 13a and the second electrode sheet 14a are intended to be unwound from the respective coils 11, 12, 13, 14 and to be fed to a conveyor 20 along respective feeding directions D1, D2, D3, D4 preferably parallel to one other.

In the embodiment illustrated in FIG. 1, first deviating rollers 16a are arranged alongside the coils 11, 12, 13, 14 to deviate 20 the sheets 11a, 12a, 13a, 14a unwound from the coils 11, 12, 13, 14 towards the conveyor and respective pairs of second deviating rollers 16b are arranged downstream of the first deviating rollers 16 with reference to the feeding directions D1, D2, D3 and D4 to convey the sheets 11a, 12a, 13a, 14a deviated by the first diverter rollers 16a towards the conveyor 20.

In the illustrated embodiment, the service area 10 is arranged in a first chamber under atmospheric environmental conditions. The conveyor 20 is arranged in a second chamber 20a configured to maintain dry environmental conditions. Respective interfaces 17 are provided at each coil 11, 12, 13, 14 between the first chamber 10a and the second chamber 20a. Interfaces 17 are configured to let the sheets 11a, 12a, 13a, 14a directed towards the conveyor 20 pass while maintaining the dry environmental conditions of the second chamber 20a.

First cutting members 21, 22, 23, 24 are arranged between the service area 10 and the conveyor 20, preferably in the second chamber 20a, each along the respective feeding direction D1, D2, D3, D4 to intercept the sheets 11a, 12a, 13a, 14a and cut them longitudinally into parallel strips 11b, 12b, 13b, 14b. The cross-sectional width of the strips 11b, 12b, 13b, 14b thus obtained is chosen according to the axial length of the electrical battery to be produced. In the preferred embodiment illustrated, each strip 11b, 12b, 13b, 14b thus obtained has a cross-sectional width comprised between 70 and 90 mm, e.g. approximately 80 mm.

FIG. 2 shows the strips 12b obtained following the longitudinal cut of the first electrode sheet 12a.

In a possible embodiment, each of the first cutting members 21; 22; 23; 24 comprises, for example, a pair of counter-rotating rollers configured to receive between them a respective sheet 11a, 12a, 13a, 14a and provided with respective blades configured to longitudinally cut the sheets 11a, 12a, 13a, 14a.

In FIG. 2 the longitudinal cuts 12c made by the first cutting member 22 on the first electrode sheet 12a to form the strips 12b can be seen.

Second cutting members 26, 27, 28, 29 are arranged between the service area 10 and the conveyor 20, preferably in the second chamber 20a, each along the respective feeding direction D1, D2, D3, D4 to intercept the sheets 11a, 12a, 13a, 14a before they arrive on the conveyor 20.

In the illustrated embodiment, the second cutting members 26, 27, 28, 29 are arranged downstream of the first cutting members 21, 22, 23, 24 along the respective feeding directions D1, D2, D3, D4.

The second cutting members 26; 27; 28; 29 are configured to periodically and transversely cut the strips 11b, 12b, 13b, 14b into discrete longitudinal pieces. Each longitudinal piece has a length comprised between 5000 and 7000 mm, e.g. approximately 6000 mm.

In alternative embodiments not illustrated, the second cutting members 26, 27, 28, 29 can be arranged upstream of the first cutting members 21, 22, 23, 24 along the respective feeding directions D1, D2, D3, D4. In such a case, the second cutting members 26, 27, 28, 29 act on the sheets 11a, 12a, 13a, 14a unwound from the coils 11, 12, 13, 14 and the first cutting members 21, 22, 23, 24 act on the sheets 11a, 12a, 13a, 14a already cut into longitudinal pieces by the second cutting members 26, 27, 28, 29 to form the strips 11b, 12b, 13b, 14b.

In FIG. 2 the longitudinal cuts 12d made by the second cutting member 27 on the first electrode sheet 12a can be seen.

The conveyor 20 is preferably arranged below the service area 10 and is configured to receive the sheets 11a, 12a, 13a, 14a already cut longitudinally into parallel strips 11b, 12b, 13b, 14b by the first cutting members 21, 22, 23, 24 and transversely cut into longitudinal pieces by the second cutting members 26, 27, 28, 29.

The conveyor 20 comprises a conveyor belt 30 having a horizontal conveyor plane that can be moved along a feeding direction D.

The conveyor 20 can be moved at a speed preferably comprised between 0.5 m/s and 2 m/s, e.g. approximately 1 m/s.

The conveyor 20 receives the longitudinal pieces of the strips 11b of the first separator sheet 11a so that the longitudinal direction of these longitudinal pieces is parallel to the feeding direction D.

The conveyor 20 also receives the longitudinal pieces of the strips 12b of the first electrode sheet 12a in such a way that the longitudinal direction of these longitudinal pieces is parallel to the feeding direction D. Each of these longitudinal pieces is overlapped to a respective longitudinal piece of a respective strip 11b of the first separator sheet 11a.

Similarly, the conveyor 20 receives the longitudinal pieces of the strips 13b of the second separator sheet 13a in such a way that the longitudinal direction of these longitudinal pieces is parallel to the feeding direction D. Each of these longitudinal pieces overlaps a respective longitudinal piece of a respective strip 12b of the first electrode sheet 12a.

The conveyor finally receives the longitudinal pieces of the strips 14b of the second electrode sheet 14a in such a way that the longitudinal direction of these longitudinal pieces is parallel to the feeding direction D. Each of these longitudinal pieces is overlapped to a respective longitudinal piece of a respective strip 13b of the second separator sheet 13a.

In this way, a plurality of multi-layer strips 35 are formed on the conveyor 20, each comprising a first layer 35a defined by a longitudinal piece of a strip 11b of the first separator sheet 11a, a second layer 35b overlapped to the first layer 35a and defined by a longitudinal piece of a strip 12b of the first electrode sheet 12a, a third layer 35c overlapped to the second layer 35b and defined by a longitudinal piece of a strip 13b of the second separator sheet 13a and a fourth layer 35d overlapped to the third layer 35c and defined by a longitudinal piece of a strip 14b of the second electrode sheet 14a.

The multi-layer strips 35 obtained from a single strip 11b, a single strip 12b, a single strip 13b and a single strip 14b are arranged on the conveyor 20 one after the other along the feeding direction D while the multi-layer strips 35 obtained from parallel strips 11b, 12b, 13b, 14b are arranged on the conveyor 20 parallel to each other along a direction orthogonal to the feeding direction D.

The position of the coils 11, 12, 13, 14 with respect to the conveyor 20 is such that in each multi-layer strip 35, the strip 12b of the first electrode sheet 12a (and thus the second layer 35b) is deposited on a respective strip 11b of the first separator sheet 11a (and thus on the first layer 35a) in a position which is transversely offset with respect to the latter, each strip 13b of the second separator sheet 13a (and thus the third layer 35c) is deposited on a respective strip 12b of the first electrode sheet 12a (and thus on the second layer 35b) in a position which is transversely aligned to the underlying strip 11b of the first separator sheet 11a (and thus to the first layer 35a) and each strip 14b of the second electrode sheet 14a (and thus the fourth layer 35d) is deposited on a respective strip 13b of the second separator sheet 13 (and thus on the third layer 35c) in a position which is transversely offset from the underlying strip 11b of the first separator sheet 11a (and thus from the first layer 35a) on the opposite side to the strip 12b of the first electrode sheet 12a (and thus to the second layer 35b).

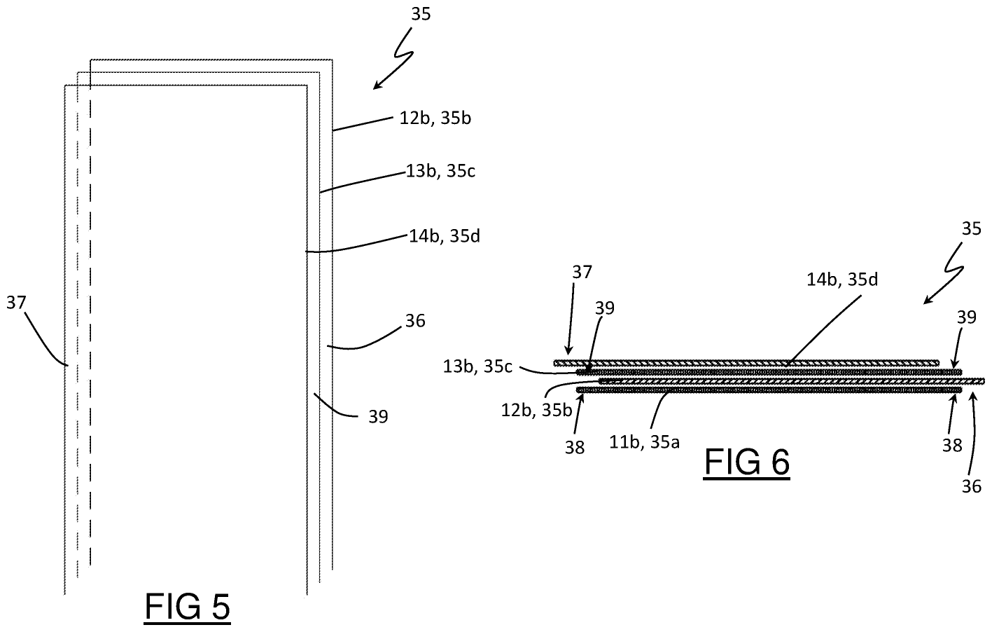

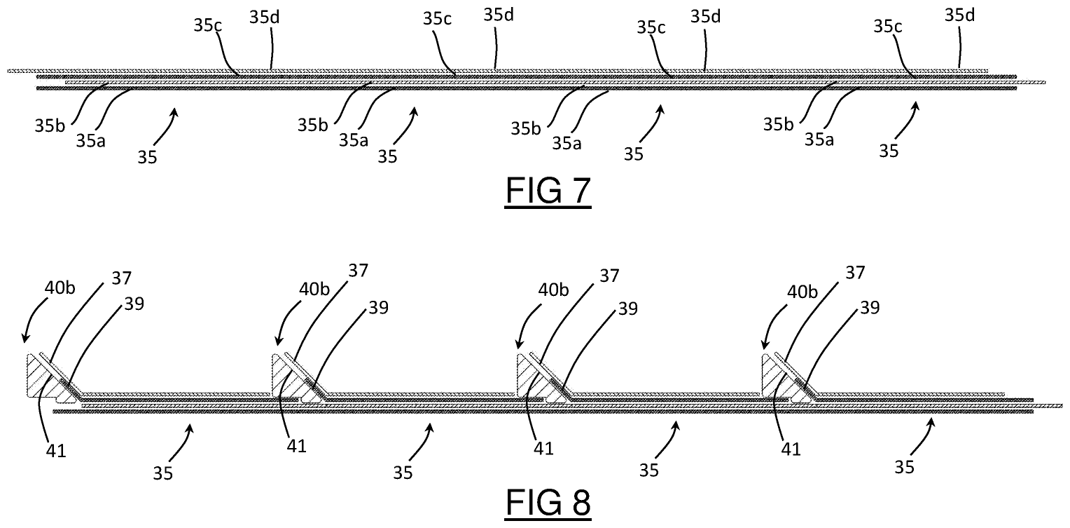

For example, the strip 12b of the first electrode sheet 12a (and thus the second layer 35b) is transversely offset by a distance comprised between 1 mm and 10 mm, preferably between 3 mm and 7 mm, e.g. about 5 mm, and the strip 14b of the second electrode sheet 14a (and thus the fourth layer 35d) is transversely offset, again with respect to the strip 11b of the first separator sheet 11a (and thus to the first layer 35a) and the strip 13b of the second separator sheet 13a (and thus to the third layer 35c), on the opposite side to the strip 12b of the first electrode sheet 12a (and thus to the second layer 35b) by a similar amount, as can be seen in FIGS. 5 and 6.

In this way, a protruding side edge 36 of the first electrode sheet which protrudes on one side with respect to the strips 11b, 13b of the separator sheets 11a, 13a and a protruding side edge 37 of the second electrode sheet 14a which protrudes with respect to the strips 11b, 13b of the separator sheets 11a, 13a on the opposite side with respect to the protruding side edge 36 of the first electrode sheet 12a are created in each multi-layer strip 35.

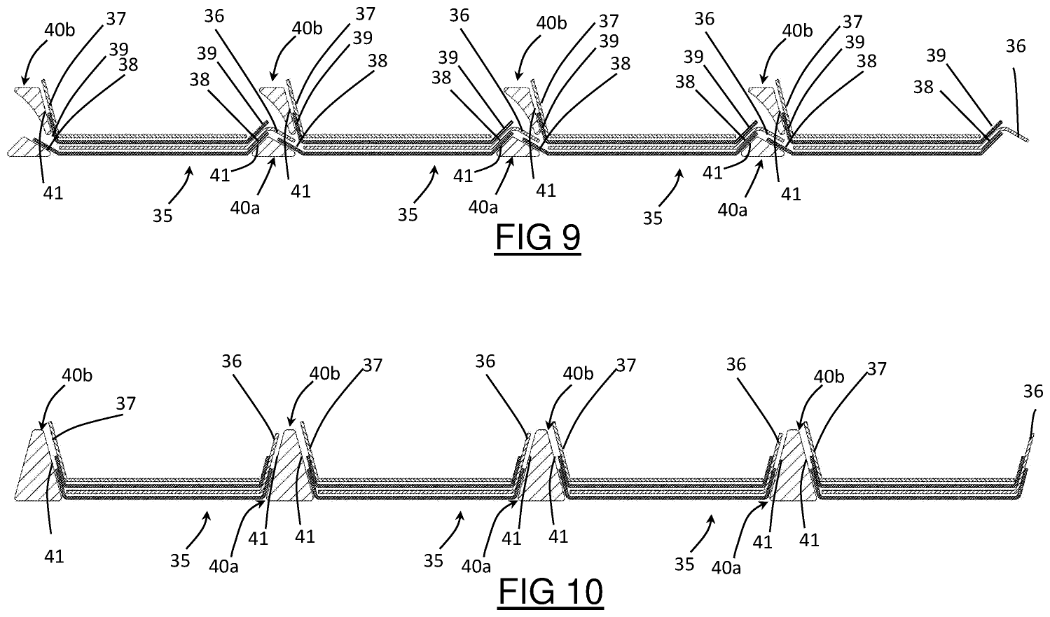

A plurality of first bending members 40a, illustrated in FIGS. 9-10, is arranged on the conveyor 20. The first bending members 40a extend lengthwise along the feeding direction D. The first bending members 40a are arranged parallel to each other and each of them is configured to intercept the protruding side edge 36 of the first electrode sheet 12a of a respective multi-layer strip 35 and bend it longitudinally upwards.

Similarly, a plurality of second bending members 40b, illustrated in FIGS. 8-10, is arranged on conveyor 20. The second bending members 40b extend lengthwise along the feeding direction D. The second bending members 40b are arranged parallel to each other, side-by-side with the first bending members 40a and each of them is configured to intercept the protruding side edge 37 of the second electrode sheet 14a of a respective multi-layer strip 35 and bend it longitudinally upwards.

The bending elements 40a, 40b have respective helical profiles 41 which extend along a helical axis parallel to the feeding direction D starting from a substantially horizontal orientation to an orientation progressively more inclined with respect to the horizontal plane moving along the feeding direction D.

As illustrated for example in FIG. 9, in the illustrated embodiment, the opposing side edges 38 of the strips 11b of the separator sheets 11a and the opposing side edges 39 of the strips 13b of the separator sheets 13a are also bent longitudinally together with the protruding side edges 36, 37 of the strips 12b, 14b of the electrode sheets 12a, 14a.

A plurality of winding devices 50 is arranged downstream of the conveyor 20 with reference to the feeding direction D.

Each winding devices 50 is configured to receive a respective multi-layer strip 35.

Each winding device 50 may, for example, comprise a motorised pin around which the multi-layer strip 35 is wound to form an electrochemical cell of the jelly roll type.

As illustrated in detail in FIG. 2A, an additional winding device 50a is arranged next to each winding device 50 so as to replace the winding device 50 at the end of the winding of the longitudinal piece of multi-layer strip 35 onto it so as to receive the next longitudinal piece of multi-layer strip 35.

In the embodiment shown in FIGS. 1 and 2, the winding devices 50 are arranged offset along the feeding direction D to allow the housing of the components required for their operation.

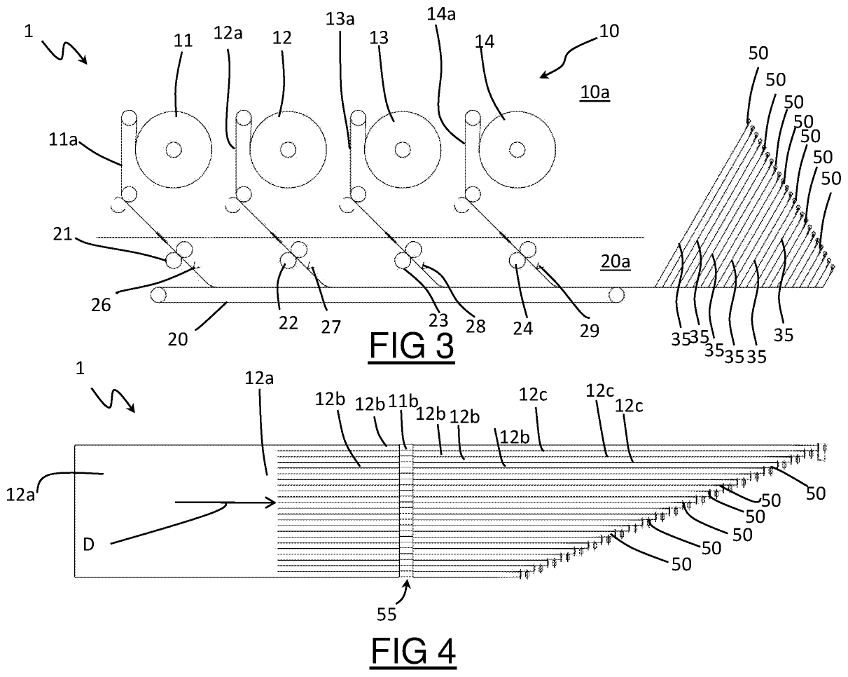

FIGS. 3 and 4 show an apparatus 1 similar to that of FIG. 1 or 2 with the difference that the winding devices 50 are arranged offset along a direction inclined with respect to the feeding direction D, and preferably also with respect to a horizontal plane, so that all the multi-layer strips 35 travel the same distance from when they are formed on the conveyor 20 to when they reach the respective winding device 50. The offset of the winding devices 50 can also depend on the mutual position of the coils 11, 12, 13, 14 and on the position of the latter with respect to the conveyor 20 so that the sheets 11a, 12a, 13a and 14a all travel the same distance from when they are unwound from the coils 11, 12, 13, 14 to when they are deposited in strips 11b, 12b, 13b, 14c on the conveyor 20 forming the multi-layer strips 35.

In this embodiment, each second cutting member 26, 27, 28, 29 can be configured to transversely cut the strips 11b, 12b, 13b, 14b of the respective sheet 11a, 12a, 13a, 14a through a single straight transverse cut. The longitudinal pieces of the strips 11b, 12b, 13b, 14b of each sheet 11a, 12a, 13a, 14a thus obtained are aligned transversely, as can be seen in FIG. 4.

In the embodiment of FIGS. 3 and 4, the second cutting members 26, 28 can be arranged between the conveyor 20 and the winding devices 50 in such a way that the strips 11b, 13b of the separator sheets 11a, 13a extend continuously between the coils 11, 13 and the conveyor 20 and are cut transversely upstream of the winding devices 50.

In this embodiment, the second cutting members 26, 27, 28, 29 can also be configured to transversely cut the strips 11b, 12b, 13b, 14b of each multi-layer strip 35 at positions which are mutually longitudinally offset. In this way, the longitudinal pieces of some of the strips 11b, 12b, 13b, 14b protrude with respect to the others at the longitudinal ends of each longitudinal piece of multi-layer strip 35.

In the embodiment of FIG. 4, the second cutting members 26, 27, 28, 29 are configured to cut the longitudinal pieces of the strips 12b, 14b of the electrode sheets 12a, 14a so that they are longitudinally shorter than the longitudinal pieces of the strips 11b, 13b of the separator sheets 11a, 13a. In this way, the longitudinal pieces of the strips 11b, 13b of the separator sheets 11a, 13a protrude longitudinally with respect to the longitudinal pieces of the strips 12b, 14b of the electrode sheets 12a, 14a at the longitudinal ends of each longitudinal piece of multi-layer strip 35.

FIG. 4 shows respective breaks 55 between successive longitudinal pieces of the strips 12b of the first electrode sheets 12a.

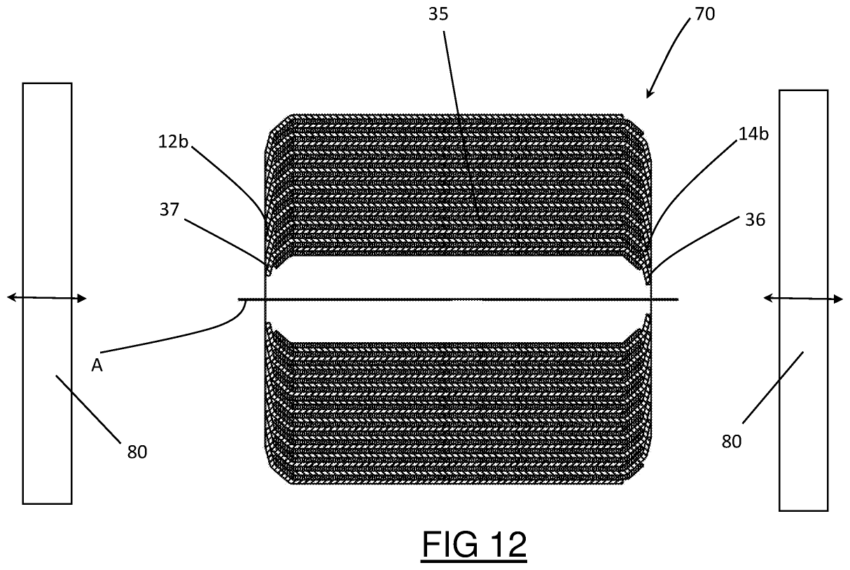

As illustrated in FIG. 12, a pair of presser members 80 is provided at each winding device 50, the presser members being configured to flatten the protruding side edges 36, 37 which, following the winding of the multi-layer strip 35 onto the winding device 50, protrude axially, tilting them towards the winding axis A of the respective winding device 50.

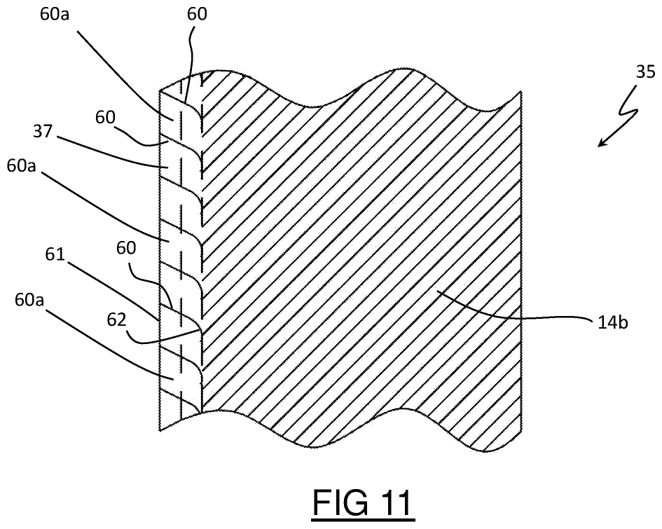

In an embodiment, third cutting members (not illustrated) are provided. The third cutting member are configured to make a plurality of transverse cuts 60, illustrated in FIG. 11, on the edges of the strip 12b of the first electrode sheet 12a and the strip 14b of the second electrode sheet 14a which are intended to form the protruding side edges 36, 37.

The third cutting members can for example include inserts mounted on the rollers of the first cutting members 22, 24 or a computer numerical control laser cutting device.

The third cutting members are configured to make each cut 60 from a free end 61 of the side edge of the respective strip 12b, 14b in an oblique direction towards the inside of the strip 12b, 14b to make a curved inner end 62.

For example, the cuts 60 can be sinusoidal or J-shaped.

The plurality of cuts 60 defines a plurality of notches 60a on the protruding side edges 36, 37 configured to be bent by the bending members 40a, 40b and overturned by the abovementioned presser members 80.

For simplicity of illustration, in FIG. 11 the numerical references 60, 61, 62, 60a are shown at some of these cuts 60.

In order to make electrochemical cells of electrical batteries, four coils 11, 12, 13, 14 of the type described above are prepared, these coils comprising a winding of the first separator sheet 11a, a winding of the first electrode sheet 12a, a winding of the second separator sheet 13a and a winding of the second electrode sheet 14a, respectively.

The four coils 11, 12, 13, 14 can be formed under atmospheric environmental conditions and the respective sheets 11a, 12a, 13a, 14a can be subjected to contaminant removal treatments such as, for example, solvent evaporation treatments, before being wound into the respective coils 11, 12, 13, 14.

The four coils 11, 12, 13, 14 are mounted on the respective supports 15 provided in service area 10. In the illustrated embodiment, the service area 10 is maintained under atmospheric environmental conditions during the unwinding of the coils 11, 12, 13, 14. In alternative embodiments not illustrated, the service area 10 is kept in dry environmental conditions during the unwinding of the coils 11, 12, 13, 14.

In the preferred embodiment illustrated, the four coils 11, 12, 13, 14 are arranged in the following manner with respect to the feeding direction D, starting from the most upstream to the most downstream: first coil 11, second coil 12, third coil 13 and fourth coil 14.

In a different embodiment not illustrated, the four coils 11, 12, 13, 14 can be arranged with the following arrangement with respect to the feeding direction D, starting from the most upstream to the most downstream: second coil 12, first coil 11, fourth coil 14 and third coil 13.

The sheets 11a, 12a, 13a and 14a are unwound from the respective coils 11, 12, 13, 14 and fed towards the conveyor 20 along the feeding directions D1, D2, D3, D4.

In an embodiment not shown, the sheets 11a, 12a, 13a and 14a are treated after being unwound from the respective coils 11, 12, 13, 14 to remove any impurities.

In the preferred embodiment shown, the sheets 11a, 12a, 13a and 14a pass through the respective interfaces 17 to enter the second chamber 20a, having dry environmental conditions. This can be avoided by providing embodiments in which the conveyor 20 is also maintained in atmospheric environmental conditions.

Subsequently, the sheets 11a, 12a, 13a, 14a are cut longitudinally by the cutting members 21; 22; 23; 24 to form from each of them a plurality of parallel strips 11b, 12b, 13b and 14b.

The strips 11b, 12b, 13b and 14b are then cut periodically and transversely by the second cutting members 26, 27, 28, 29 into a plurality of longitudinal pieces.

In the embodiment of FIGS. 3, 4 the strips 11b, 12b, 13b, 14b of each sheet 11a, 12a, 13a, 14a are all cut together by a single straight transverse cut.

The strips 11b, 12b, 13b, 14b of each multi-layer strip 35 may be cut in longitudinally mutually offset positions so that, at the longitudinal ends of each longitudinal piece of multi-layer strip 35, the longitudinal pieces of some of the strips 11b, 12b, 13b, 14b protrude with respect to the others.

In the embodiment of FIG. 3, 4, the feeding of the strips 12b, 14b of the electrode sheets 12a, 14a onto the conveyor 20 is temporarily slowed down or stopped before or after they are cut transversely so as to form a gap 55 between successive longitudinal pieces of the strips 12b, 14b.

In an embodiment not illustrated, the cuts 60 are made on a side edge of the strip 12b of the first electrode sheet 12a (said side edge being the one intended to form the protruding side edge 36 of the first electrode sheet 12a) and on a side edge of the strip 14b of the second electrode sheet 14a (said side edge being the one intended to form the protruding side edge 37 of the second electrode sheet 14a). These cuts 60 define the notches 60a on the protruding side edges 36, 37.

The longitudinal pieces of the parallel strips 11b, 12b, 13b and 14b are then deposited on the conveyor 20.

In the preferred embodiment illustrated, at first the strips 11b of the first separator sheet 11a (in particular the longitudinal pieces of the strips 11b) are deposited, then the strips 12b of the first electrode sheet 12a (in particular the longitudinal pieces of the strips 12b are deposited on the longitudinal pieces of the strips 11b while other longitudinal pieces of the strips 11b are deposited on the conveyor 20) then the strips 13b of the second separator sheet 13a (in particular the longitudinal lengths of the strips 13b are deposited on the longitudinal pieces of the strips 12b while other longitudinal pieces of the strips 12b are deposited on the longitudinal pieces of the strips 11b), and finally the strips 14b of the second electrode sheet 14a (in particular the longitudinal pieces of the strips 14b are deposited on the longitudinal pieces of the strips 13b while other longitudinal pieces of the strips 13b are deposited on the longitudinal pieces of the strips 12b).

The order of the strips 11b, 12b, 14b from the bottom to the top on the conveyor 20 corresponds to the order of the coils 11, 12, 13, 14 from upstream to downstream with respect to the feeding direction D.

Longitudinal pieces of planar, adjacent and parallel multi-layer strips 35 are thus formed on the conveyor 20, each of said longitudinal pieces comprising respective layers 35a, 35b, 35c, 35d which are offset as described above so as to form in each longitudinal piece of multi-layer strip 35 the protruding side edge 36 of the first electrode sheet 12a and the protruding side edge 37 of the second electrode sheet 14a

As the longitudinal pieces of the multi-layer strips 35 are formed, they are moved in the feeding direction D while keeping the conveyor belt 30 in continuous motion, so as to feed the aforementioned longitudinal pieces to the respective winding devices 50.

During the movement of the conveyor 20, the protruding side edge 36 of the first electrode sheet 12a and the protruding side edge 37 of the second electrode sheet 14a, and in the illustrated embodiment also the side edges 38 and 39 of the separator sheets 11a, and 13a are bent longitudinally upwards by the first bending members 40a and the second bending members 40b.

Next, each longitudinal piece of multi-layer strip 35 is wound onto a respective winding device 50. The longitudinal piece of multi-layer strip 35 can be wound, for example, by rotating a pin of the winding device 50. The longitudinal pieces of multi-layer strip 35 which are parallel to each other can be wound simultaneously.

In an embodiment not illustrated, the strips 12b, 14b of the electrode sheets 12a, 14a are cut periodically and transversely before being fed to the conveyor 20, while the strips 11b, 13b of the separator sheets 11a, 13a are cut periodically and transversely after being fed to the conveyor 20 and before being fed to the respective winding device 50. In this embodiment, the strips 11b, 13b of the separator sheets 11a, 13a extend continuously along the conveyor 20 and transport the longitudinal pieces 12b, 14b of the electrode sheets 12a, 14a along the conveyor 20.

Next, the protruding side edge 36 of the first electrode sheet 12a and the protruding side edge 37 of the second electrode sheet 14a are flattened.

During such flattening the projecting side edges 36, 37 may be circumferentially continuous. This creates a plurality of radial creases on the protruding side edges 36, 37.

Alternatively, the protruding side edges 36, 37 can be divided in the abovementioned notches 60a by making the cuts 60. In this case, the adjacent notches 60a partially overlap during flattening.

FIG. 12 shows a radial section of an electrochemical cell 70 consisting of a multi-layer strip 35 wrapped around the respective winding axis A and having the respective protruding side edges 36, 37 flattened.

During the winding of each multi-layer strip 35 around the respective winding device 50, an additional winding device 50a is kept at rest close to the winding device 50. Following the winding of the multi-layer strip 35 around the winding device 50, the winding device 50 is removed and the additional winding device 50a takes the place of the winding device 50.

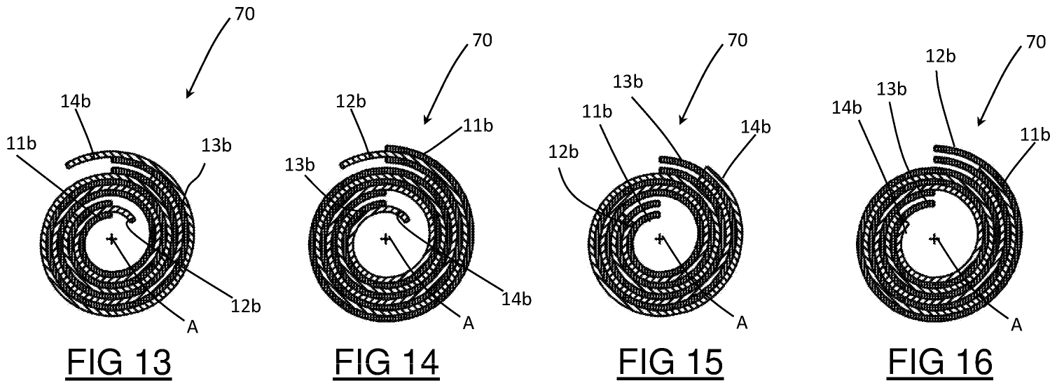

FIGS. 13-16 schematically show cross-sections of respective electrochemical cells 70 obtainable by different embodiments in accordance with the present invention.

The electrochemical cells 70 of FIGS. 13 and 15 have, moving from the inside to the outside along a radial direction: the strip 11b of the first separator sheet 11a, the strip 12b of the first electrode sheet 12a, the strip 13b of the second separator sheet 13a and the strip 14b of the second electrode sheet 14a. This distribution can be obtained by feeding the multi-layer strip 35 to the winding device 50 from above and contacting the winding device 50 with the strip 11b of the first separator sheet 11a.

The electrochemical cells 70 of FIGS. 14 and 16 have, moving from the outside to the inside along a radial direction: the strip 11b of the first separator sheet 11a, the strip 12b of the first electrode sheet 12a, the strip 13b of the second separator sheet 13a and the strip 14b of the second electrode sheet 14a. This distribution is obtained by feeding the multi-layer strip 35 to the winding device 50 from below and contacting the winding device 50 with the strip 14b of the second electrode sheet 14a.

In the electrochemical cells 70 of FIGS. 13 and 14, the longitudinal pieces of the strips 12b, 14b of the electrode sheets 12a, 14a are circumferentially offset from the longitudinal pieces of the strips 11b, 13b of the separator sheets 11a, 13a. This is achieved by transversely cutting the sheets 11a, 12a, 13a, 14a at longitudinally offset positions, as described above.

In the electrochemical cells 70 of FIGS. 15 and 16, the longitudinal pieces of the strips 12b, 14b of the electrode sheets 12a, 14a are shorter than the longitudinal pieces of the strips 11b, 13b of the separator sheets 11a, 13a. This is achieved by forming a gap 55 between successive longitudinal pieces of the electrode sheets 12a, 14a, as described above. In these embodiments, it is possible, after winding the multi-layer strip 35, to melt together the protruding portions of the separator sheets 11a, 13a to stabilise the electrochemical cell 70.

In an embodiment not illustrated in which the conveyor 20 is maintained under atmospheric environmental conditions the electrochemical cells 70 after winding are subjected to a drying process, e.g. by vacuum drying, after having been wound. Obviously, a person skilled in the art, in order to satisfy specific and contingent needs, can make numerous changes and variations to the invention described above while remaining within the scope of protection defined by the following claims.

1. A method for forming electrochemical cells of electrical batteries, comprising:
preparing a coil comprising a winding of a first separator sheet, a coil comprising a winding of a first electrode sheet, a coil comprising a winding of a second separator sheet and a coil comprising a winding of a second electrode sheet;
feeding said sheets towards a conveyor by unwinding them from their respective coils;
forming on the conveyor a plurality of multi-layer strips each one comprising a first layer of said first separator sheet, a second layer of said first electrode sheet overlapped to said first layer, a third layer of said second separator sheet overlapped to said second layer and a fourth layer of said second electrode sheet overlapped to said third layer, said conveyor being movable along a feeding direction;
feeding each multi-layer strip to a respective winding device by said conveyor;
winding each multi-layer strip onto the respective winding device.

2. The method according to claim 1, comprising, before forming on the conveyor said plurality of multi-layer strips:
forming a plurality of parallel strips of each of said sheets by cutting each of said sheets longitudinally when it is fed towards the conveyor;
depositing on the conveyor at first the parallel strips of the first separator sheet, then the parallel strips of the first electrode sheet, then the parallel strips of the second separator sheet and then the parallel strips of the second electrode sheet.

3. The method according to claim 2, wherein:
the parallel strips of the first electrode sheet are deposited on the conveyor in a transversely offset position with respect to the parallel strips of the first separator sheet to create, in each multi-layer strip, a protruding side edge of the first electrode sheet;
the parallel strips of the second separator sheet are deposited on the conveyor in a transversely offset position with respect to the parallel strips of the first electrode sheet;
the parallel strips of the second electrode sheet are deposited on the conveyor in a transversely offset position with respect to the parallel strips of the first separator sheet and the second separator sheet and opposite to the protruding side edge of the first electrode sheet to create, in each multi-layer strip, a protruding side edge of the second electrode sheet.

4. The method according to claim 3, comprising, before winding each multi-layer strip onto the respective winding device, bending longitudinally the protruding side edge of the first electrode sheet and the protruding side edge of the second electrode sheet.

5. The method according to claim 4, wherein:
bending longitudinally the protruding side edge of the first electrode sheet comprises intercepting the protruding side edge of the first electrode sheet by a first bending member while the conveyor is moved along said feeding direction;
bending longitudinally the protruding side edge of the second electrode sheet comprises intercepting the protruding side edge of the second electrode sheet by a second bending member while the conveyor is moved along said feeding direction.

6. The method according to claim 5, comprising, after winding each multi-layer strip onto the respective winding device, flattening the protruding side edge of the first electrode sheet and the protruding side edge of the second electrode sheet by overturning them towards a winding axis of the respective winding device.

7. The method according to claim 4, comprising, before winding each multi-layer strip onto the respective winding device, making a plurality of cuts on said protruding side edges.

8. The method according to claim 7, wherein said plurality of cuts extend from a free end of said protruding side edges to a curved inner end.

9. The method according to claim 1, comprising, before winding each multi-layer strip onto the respective winding device (50):
forming a plurality of longitudinal pieces of multi-layer strips; and wherein winding each multi-layer strip onto the respective winding device (50) comprises:
winding each of said longitudinal pieces onto the respective winding device.

10. The method according to claim 9, comprising, before forming on the conveyor said plurality of multi-layer layer strips:
forming a plurality of parallel strips of each of said sheets by cutting each of said sheets longitudinally when it is fed towards the conveyor;
depositing on the conveyor at first the parallel strips of the first separator sheet, then the parallel strips of the first electrode sheet, then the parallel strips of the second separator sheet and then the parallel strips of the second electrode sheet;
wherein forming said plurality of longitudinal pieces of multi-layer strips comprises cutting periodically and transversely each of said sheets before or after forming said parallel strips and before depositing said parallel strips on the conveyor.

11. An apparatus for forming electrochemical cells of electrical batteries, comprising:
a service area configured to support a coil comprising a winding of a first separator sheet, a coil comprising a winding of a first electrode sheet, a coil comprising a winding of a second separator sheet and a coil comprising a winding of a second electrode sheet;
a conveyor configured to support a plurality of multi-layer strips each one comprising a first layer of said first separator sheet, a second layer of said first electrode sheet overlapped to said first layer, a third layer of said second separator sheet overlapped to said second layer and a fourth layer of said second electrode sheet overlapped to said third layer, said conveyor being movable along a feeding direction;
a plurality of winding devices arranged downstream of said conveyor with reference to said feeding direction and each configured to receive each a respective multi-layer strip.

12. The apparatus according to claim 11, further comprising first cutting members arranged between said service area and the conveyor and configured to cut longitudinally into parallel strips each of said sheets.

13. The apparatus according to claim 11, further comprising second cutting members arranged between said service area and the conveyor and configured to periodically and transversely cut each of said sheets.

14. The apparatus according to claim 11, comprising a plurality of bending members arranged parallel to each other above said conveyor, extending along a direction parallel to said feeding direction and configured to intercept respective side edges of said multi-layer strips.

15. The apparatus according to claim 14, wherein each of said bending members (40a, 40b) has a helicoidal profile.
